(19) United States
(12) Patent Application Publication
(10) Pub. No.: US 2011/0060883 A1
(43) Pub. Date: Mar. 10, 2011

(54) METHOD AND APPARATUS FOR EXTERNAL LOGICAL STORAGE VOLUME MANAGEMENT

(75) Inventor: Toshio OTANI, Sunnyvale, CA (US)

(73) Assignee: HITACHI, LTD., Tokyo (JP)

(21) Appl. No.: 12/555,154

(22) Filed: Sep. 8, 2009

(51) Int. Cl. G06F 12/00; G06F 12/16

(52) U.S. Cl. 711/162; 711/170; 711/E12.001; 711/E12.103

(57) ABSTRACT

Exemplary embodiments provide logical volume management between multiple storage subsystems or between one or more storage subsystems and a storage service. In one embodiment, a system has a host computer, a storage subsystem, an external system connected with the storage subsystem, and a management computer. The storage subsystem comprises a volume I/O control to expose one or more volumes in the storage subsystem to the host computer to provide storage I/O capability; and a volume management control to allow the management server to operate a second volume in the external system by operating a first volume in the storage subsystem. The volume management control is configured, in response to a command from the management server to create/delete the first volume, to create/delete the first volume and to create/delete the second volume.

### BACKGROUND OF THE INVENTION

The present invention relates generally to a storage subsystem having multiple disk drives and, more particularly, to logical volume management between multiple storage subsystems or between one or more storage subsystems and a storage service such as a cloud storage computing service.

Storage virtualization technology allows an administrator to manage an external storage resource as an internal virtual storage resource. The actual data of the internal virtual storage resource is stored in the external storage resource, and the external storage resource is managed by a storage subsystem which has storage virtualization technology.

Currently, there are a number of typical storage virtualization technologies. One involves a 1st first storage subsystem which virtualizes an external 2nd storage subsystem. The 1st storage subsystem exposes the logical volume of the external 2nd storage subsystem (external logical volume) to the host computer as the logical volume of the 1st storage subsystem (internal logical volume). The 1st storage subsystem gets an I/O request from the host computer and transfers its I/O request to the external 2nd storage subsystem. The 1st storage subsystem manages the mapping table between the external logical volume and the internal logical volume.

In another storage virtualization scheme, the 1st storage subsystem virtualizes an external storage service such as an HTTP server based storage service (cloud storage service). The 1st storage subsystem uses the storage resource of the external storage service as the portions of its internal logical volume. For instance, a portion of the internal logical volume data is stored into the external storage service as URI (Uniform Resource Identifier such as HTTP URL, FTP file and so on; a page data of the internal logical volume is a single URI of the external storage service). The 1st storage subsystem gets an I/O request from the host computer and it transfers its I/O request to the external storage service. The 1st storage subsystem manages the mapping table between the external resource such as URI and the internal logical volume (portion address of the internal logical volume).

Current solutions have the following problem. When the administrator or management server manages the external storage resource (e.g., create, delete, change size of logical volume), it needs to access the external storage resource directly. However, not every external storage resource owns its management interface and/or has the capability to allow direct access against management servers. For instance, most cloud storage services do not allow the administrator or management server to create a logical volume because most cloud storage services do not deal with or care about logical volume, but instead deal with URI, files, and so on. Currently, there are no methods to manage a logical volume on an external storage resource.

### BRIEF SUMMARY OF THE INVENTION

Exemplary embodiments of the invention provide logical volume management between multiple storage subsystems or between one or more storage subsystems and a storage service such as a cloud storage computing service. The subject matter of the present invention is related to those of U.S. patent application Ser. No. 11/826,853, filed Jul. 19, 2007, and U.S. patent application Ser. No. 12/476,435, filed Jun. 2, 2009, the entire disclosures of which are incorporated herein by reference.

An aspect of the present invention is directed to a system having a host computer, a storage subsystem, an external system connected with the storage subsystem, and a management computer for managing one or more storage volumes in the external system via the storage subsystem. The storage subsystem comprises a volume I/O control to expose one or more volumes in the storage subsystem to the host computer to provide storage I/O capability; and a volume management control to allow the management server to operate a second volume in the external system by operating a first volume in the storage subsystem. The volume management control is configured, in response to a command from the management server to create the first volume, to create the first volume in the storage subsystem and to create the second volume in the external system, and in response to a command from the management server to delete the first volume, to delete the first volume in the storage subsystem and to delete the second volume in the external system. Data in the first volume is stored in the second volume.

In some embodiments, the volume management control creates an external volume management table for the first volume and the second volume in response to the command to create the first volume, and the volume management control deletes an external volume management table for the first volume and the second volume in response to the command to delete the first volume. The external volume management table provides configuration information and mapping information of the first volume and the second volume to manage configuration and mapping of the first volume and the second volume. The volume I/O control processes read/write I/O from the host computer to the first volume. The storage subsystem further comprises an external volume I/O control which transfers the read/write I/O, from the host computer for the first volume, to the second volume in the external system. The external system is one of a storage service system having multiple URI (Uniform Resource Identifier) resources or another storage subsystem.

In specific embodiments, the external system is a second storage subsystem. The storage subsystem further comprises an external volume I/O control which communicates with a second volume I/O control of the second storage subsystem to access the second volume in the second storage subsystem. The volume management control communicates with a second volume management control of the second storage subsystem to operate the second volume in the second storage subsystem.

In specific embodiments, the external system is a second storage subsystem. The storage subsystem further comprises an external volume I/O control which communicates with a second volume I/O control of the second storage subsystem to access the second volume in the second storage subsystem, and utilizes one or more volumes in the second storage subsystem as a storage pool.

Another aspect of the present invention is directed to a system having a host computer, a storage subsystem, an external system connected with the storage subsystem, and a management computer for managing one or more storage volumes in the external system via the storage subsystem. The storage subsystem comprises a volume I/O control to expose one or more volumes in the storage subsystem to the host computer to provide storage I/O capability; and a volume management control to allow the management server to operate a second volume in the external system by operating a first volume in the storage subsystem. The volume management control is configured, in response to a command other than a read/write command from the management server to operate the first volume, to apply the command to the first volume in the storage subsystem and to apply the command to the second volume in the external system. Data in the first volume is stored in the second volume.

In some embodiments, the command is one of a create command to create the first volume, a delete command to delete the first volume, a change attribute command to change attribute of the first volume, a copy command to copy the first volume, or a move command to move the first volume. In response to the create command, the volume management control creates the first volume in the storage subsystem and creates the second volume in the external system. In response to the delete command, the volume management control deletes the first volume in the storage subsystem and deletes the second volume in the external system. In response to the change attribute command, the volume management control changes attribute of the first volume in the storage subsystem and changes attribute of the second volume in the external system. In response to the copy command, the volume management control copies the first volume to a first target volume in the storage subsystem, and copies the second volume to a second target volume in the external system. In response to the move command, the volume management control copies the first volume to a first target volume in the storage subsystem and deletes the first volume, and copies the second volume to a second target volume in the external system and deletes the second volume.

In specific embodiments, in response to the create command, the volume management control creates an external volume management table for the first volume and the second volume. In response to the delete command, the volume management control deletes an external volume management table for the first volume and the second volume. In response to the change attribute command, the volume management control updates the external volume management table for the first volume and the second volume based on change in the attributes of the first volume and the second volume. In response to the copy command, the volume management control creates another external volume management table for the first target volume and the second target volume. In response to the move command, the volume management control creates another external volume management table for the first target volume and the second target volume, and deletes the external volume management table for the first volume and the second volume. The other external volume management table provides configuration information and mapping information of the first target volume and the second target volume to manage configuration and mapping of the first target volume and the second target volume. The external system provides no management capability and no management interface to the management computer.

Another aspect of the invention is directed to a system having a host computer, a storage subsystem, an external system connected with the storage subsystem, and a management computer for managing one or more storage volumes in the external system via the storage subsystem. The storage subsystem comprises a volume I/O control to expose one or more volumes in the storage subsystem to the host computer to provide storage I/O capability; and a volume management control to allow the management server to operate a second volume in the external system by operating a first volume in the storage subsystem and to manage the first volume and the second volume using an external volume management table stored in the storage subsystem. The external volume management table provides configuration information and mapping information of the first volume and the second volume to manage configuration and mapping of the first volume and the second volume. Data in the first volume is stored in the second volume. The external system has a Hypertext Transfer Protocol interface.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of a system in which the method and apparatus of the invention may be applied.

FIG. 2 shows a software module configuration of the memory in the first storage subsystem of FIG. 1.

FIG. 3 illustrates an example of the configuration of a storage service system.

FIG. 4 illustrates an example of logical volume management between a storage subsystem and a storage service system.

FIG. 5 illustrates an example of an external logical volume management table.

FIG. 6 illustrates an example of the system configuration for external logical volume management.

FIG. 7 illustrates an example of a flow diagram of managing an external logical volume in the system of FIG. 6.

FIG. 8 illustrates an example of a resource management table.

FIG. 9 illustrates an example of a URI (Uniform Resource Identifier) list.

FIG. 10 illustrates an example of an external logical volume management table with attributes updated in the flow diagram of FIG. 7.

FIG. 11 illustrates another example of the system configuration for external logical volume management.

FIG. 12 illustrates another example of the system configuration for external logical volume management.

FIG. 13 illustrates an example of a flow diagram of managing an external logical volume in the system of FIG. 12.

FIG. 14 illustrates an example of an external logical volume management table created in the flow diagram of FIG. 13.

FIG. 15 illustrates an example of a logical volume management table in the system of FIG. 12.

FIG. 16 illustrates an example of an external logical volume management table with attributes updated in the flow diagram of FIG. 13.

FIG. 17 illustrates another example of the system configuration for external logical volume management.

FIG. 18 illustrates an example of an external logical volume management table in the system of FIG. 17.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods, and computer programs for logical volume management between multiple storage subsystems or between one or more storage subsystems and a storage service such as a cloud storage computing service.

1. External Cloud Logical Volume

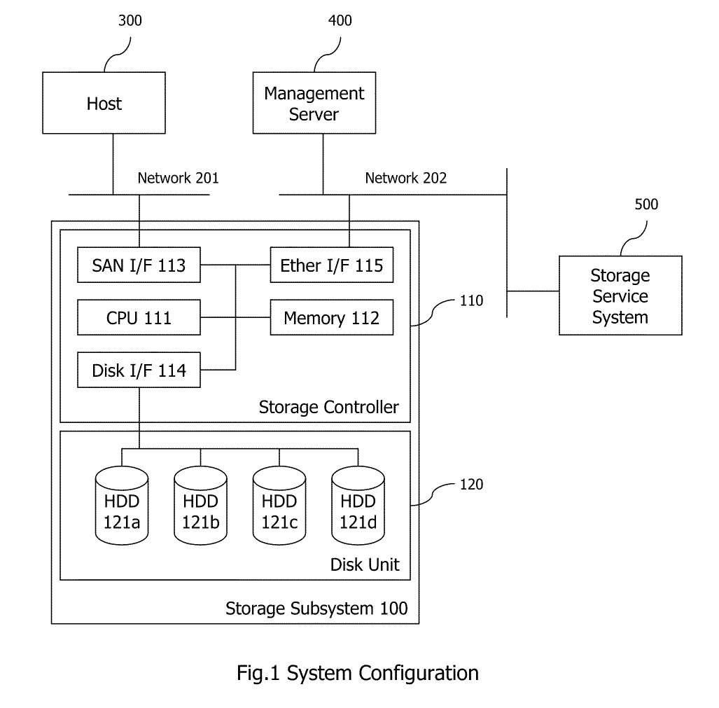

FIG. 1 illustrates an example of a hardware configuration of a system in which the method and apparatus of the invention may be applied. This embodiment involves the management of the logical volume in an external storage service such as a cloud service system. As shown in FIG. 1, the system includes at least a first storage subsystem 100, a network 201 which is typically a SAN, a network 202, an external storage service system 500, a management server 400, and a host computer 300.

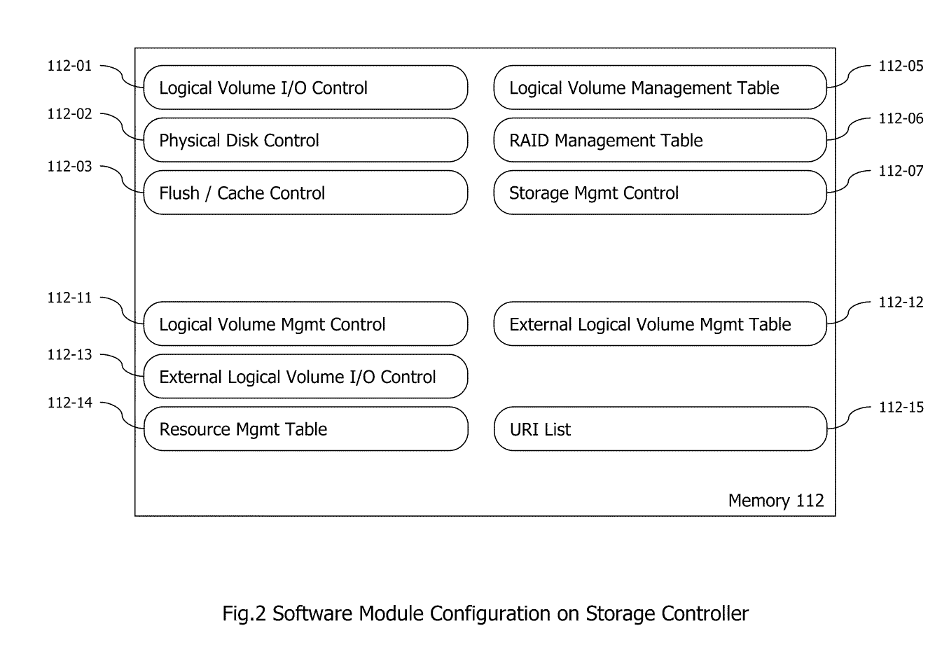

The storage subsystem 100 has a storage controller 110 and a disk unit 120. The storage controller 110 has a CPU 111, a memory 112, a SAN I/F (interface) 113, a disk I/F 114, and an Ether I/F 115. It performs disk I/O functionality from the SAN I/F 113 with the host computer 300 using Fibre Channel Protocol via the SAN 201. The disk I/F 114 is the interface between the storage controller 110 and the disk unit 120. The Ether I/F 115 of the storage controller 110 provides the interface via the network 202 with the management server 400 and the storage service system 500. The disk unit 120 has plural Hard Disk Drives (HDDs) 121 and the storage controller 110 combines these HDDs and configures RAID (Redundant Arrays of Inexpensive Disks), and then provides volume (LU: Logical Unit) to the host computer 300. These functions are executed by application programs shown in FIG. 2 (e.g., Logical Volume I/O Control, Physical Disk Control and so on).

FIG. 2 shows a software module configuration of the memory 112 in the first storage subsystem 100 of FIG. 1. It includes logical volume I/O control 112-01, physical disk control 112-02, flush/cache control 112-03, logical volume management table 112-05, RAID management table 112-06, storage management control 112-07, logical volume management control 112-11, logical volume management control 112-12, external logical volume I/O control 112-13, resource management table 112-14, and URI list 112-15.

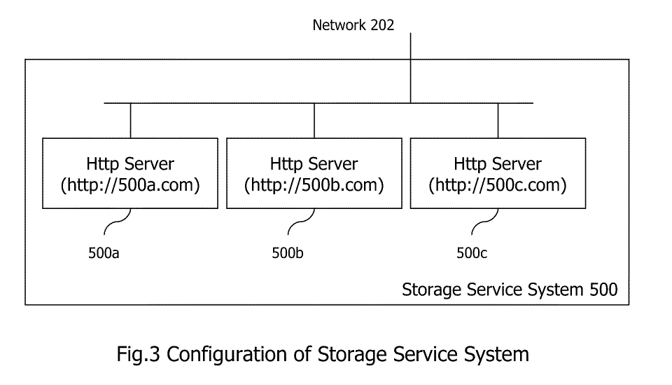

FIG. 3 illustrates an example of the configuration of the storage service system 500. It includes one or more HTTP servers 500a, 500b, 500c. In this example, each HTTP server has its own host name. The external system has a Hypertext Transfer Protocol interface.

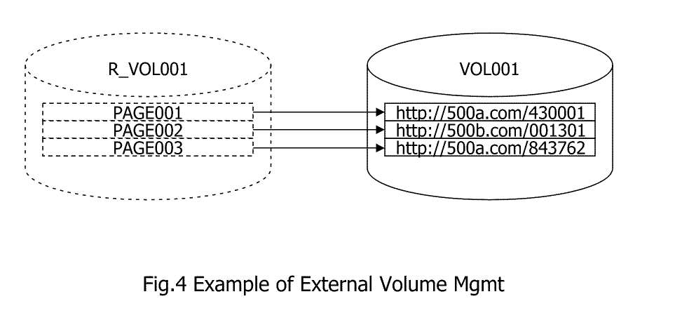

FIG. 4 illustrates an example of logical volume management between a storage subsystem (e.g., first storage subsystem 100) and a storage service system (e.g., storage service system 500). The logical volume in the first storage subsystem 100 is represented by R_VOL001, and the logical volume in the storage service system 500 is represented by VOL001. R_VOL001 includes one or more portions of data (one or more pages in FIG. 4). A page has one or more LBAs (Logical Block Addresses), for instance. The actual data of each page is stored onto VOL001, and is stored as URI (HTTP URL file) on the storage service system 500.

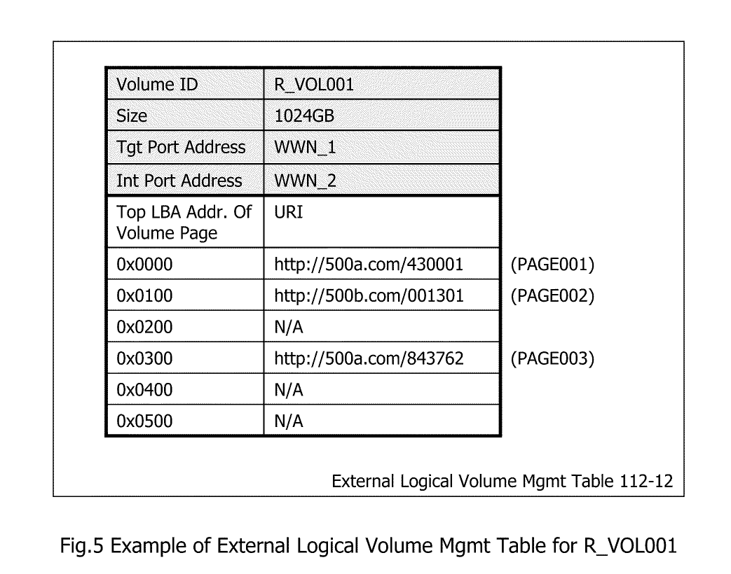

FIG. 5 illustrates an example of an external logical volume management table 112-12. It manages the attributes of R_VOL001 and the mapping between page and URI. As shown in the table 112-12, for instance, the actual data of page 001 (0x0000) is stored as http://500a.com/430001.

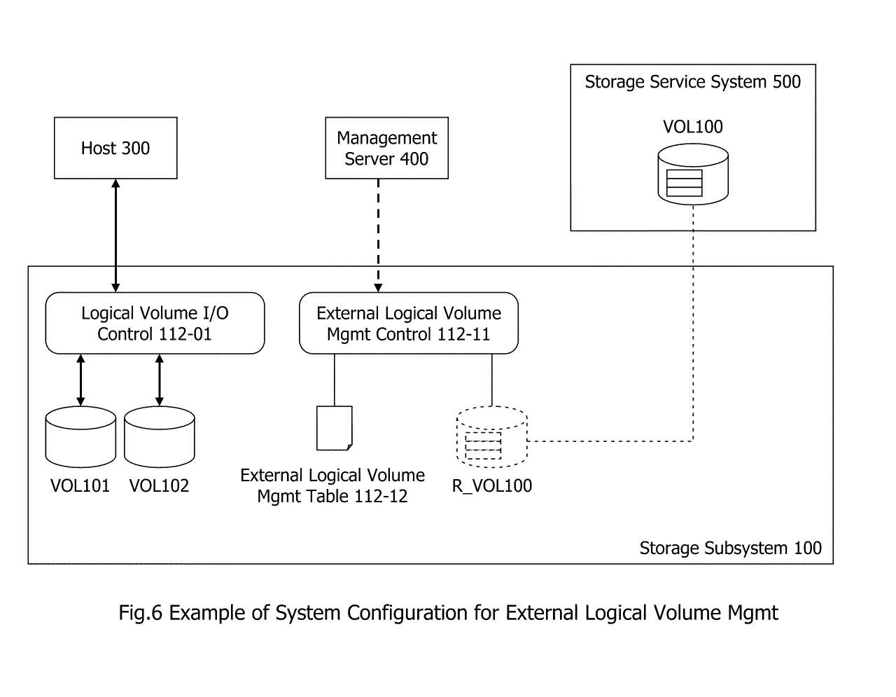

FIG. 6 illustrates an example of the system configuration for external logical volume management. The first storage subsystem 100 allows the host computer 300 to issue read/write I/O access to volumes VOL101 and VOL102 by utilizing logical volume I/O control 112-01. However, R_VOL100 is used as only managing VOL100 on the storage service system 500. The host computer 300 cannot issue read/write I/O access to R_VOL100. When the administrator needs to perform an operation on VOL100 (such as create, delete, change attributes, and the like), the management server 400 accesses the logical volume management control 112-11. The logical volume management control 112-11 allows the management server 400 to operate R_VOL100 which is the virtualized logical volume of VOL100. All operation from the management server 400 involving R_VOL100 is reflected directly to VOL100.

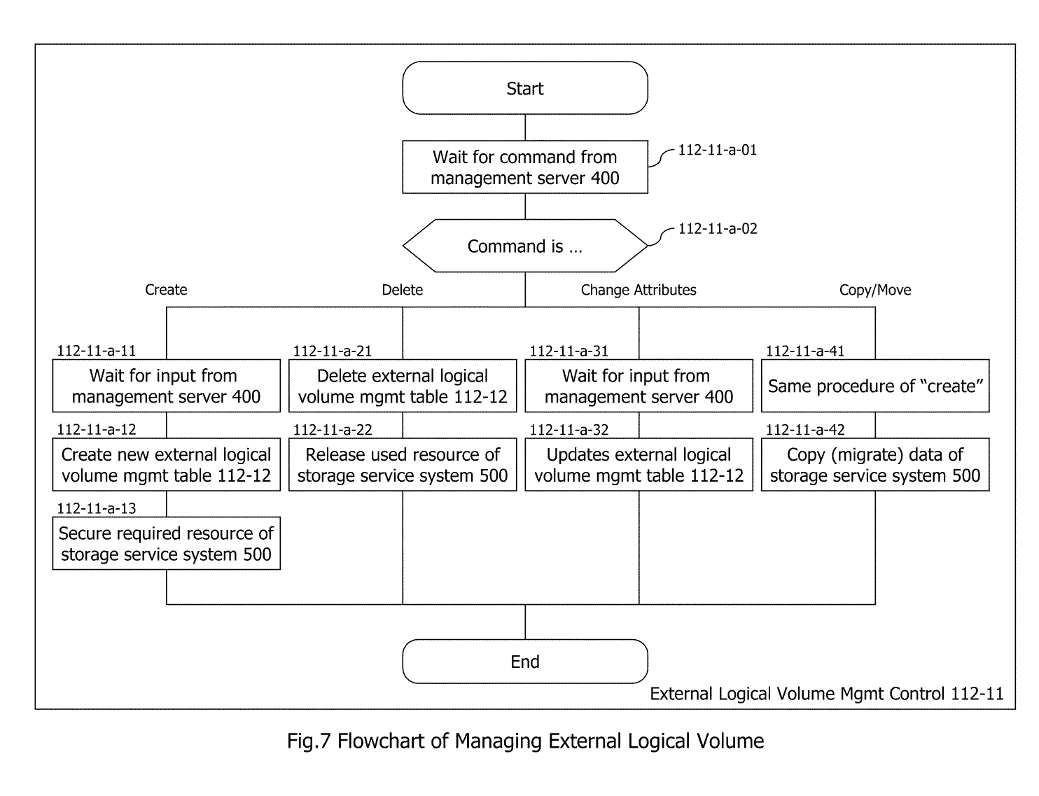

FIG. 7 illustrates an example of a flow diagram of managing an external logical volume in the system of FIG. 6. This is done by managing the external logical volume VOL100 via the virtual logical volume R_VOL100.

At first, the logical volume management control 112-11 waits for an operational command from the management server 400, administrator, or the like (112-11-a-01). The next step is to direct the process to the appropriate flow path based on what the command is (112-11-a-02).

If the command is “Create,” the logical volume management control 112-11 creates a virtual logical volume (R_VOL100) in the first storage subsystem 100 which represents the logical volume (VOL100) in the storage service system 500. The management server 400, administrator, or the like inputs the attribute information about the logical volume such as name, total size, block size, etc. (112-11-a-11). After realizing the attributes, the logical volume management control 112-11 creates a new external logical volume table 112-12 (e.g., see FIG. 5) for R_VOL100 and VOL100 (112-11-a-12). Next, the logical volume management control 112-11 secures the necessary resource of storage service system 500 for VOL100 (112-11-a-13).

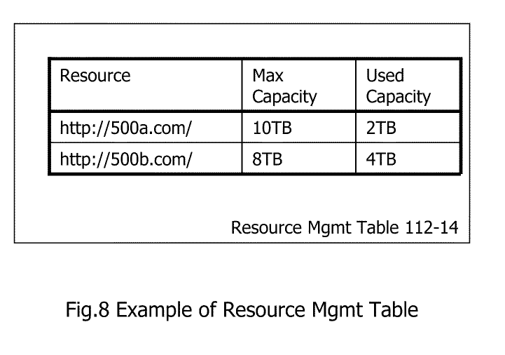

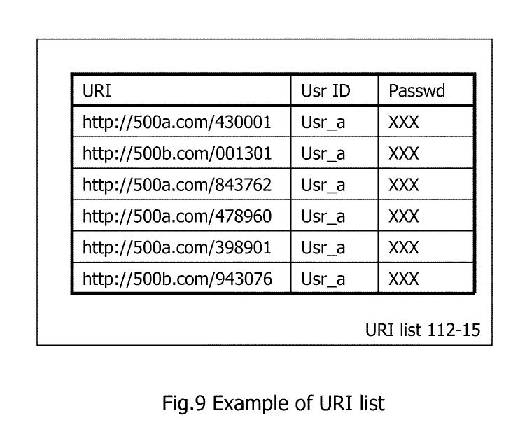

FIG. 8 illustrates an example of a resource management table 112-14. The resource management table 112-14 allows the logical volume management control 112-11 to get the necessary URI resource for R_VOL100, VOL100 from storage service system 500 (112-11-a-13 in FIG. 7). The URI list 112-15 (see, e.g., FIG. 9) prevents URI duplication by managing the used URI list 112-15.

Referring again to FIG. 7, if the command is “Delete,” the logical volume management control 112-11 deletes the external logical volume management table 112-12 for R_VOL100 and VOL100 (112-11-a-21). The logical volume management control 112-11 further updates the resource management table 112-14 and the URI list 112-15 to release URI resources that will not be required any more (112-11-a-22).

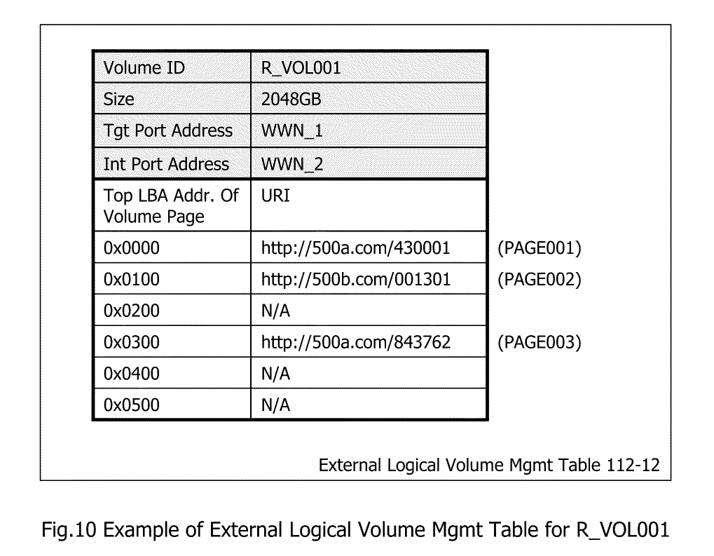

If the command is “Change Attributes,” the logical volume management control 112-11 changes the attributes of R_VOL100 and VOL100. The management server 400, administrator, or the like inputs the attribute information about R_VOL100, VOL100 (112-11-a-31), and then the logical volume management control 112-11 updates the specified attributes of R_VOL100 and VOL100 as shown in the updated external logical volume management table 112-12 of FIG. 10 (112-11-a-32). The size in FIG. 10 is changed to 2048 GB from 1024 GB in FIG. 5.

If the command is “Copy/Move,” the logical volume management control 112-11 creates another virtual logical volume (R_VOL200) in the first storage subsystem 100 which represents another logical volume (VOL200) in the storage service system 500 (112-11-a-41). Next, the logical volume management control 112-11 directs the external logical volume I/O control 112-13 to copy the data of R_VOL100 (VOL100) to R_VOL200 (VOL200). If operation is “Move,” the logical volume management control 112-11 deletes R_VOL100 (VOL100) after the copy process (112-11-a-42).

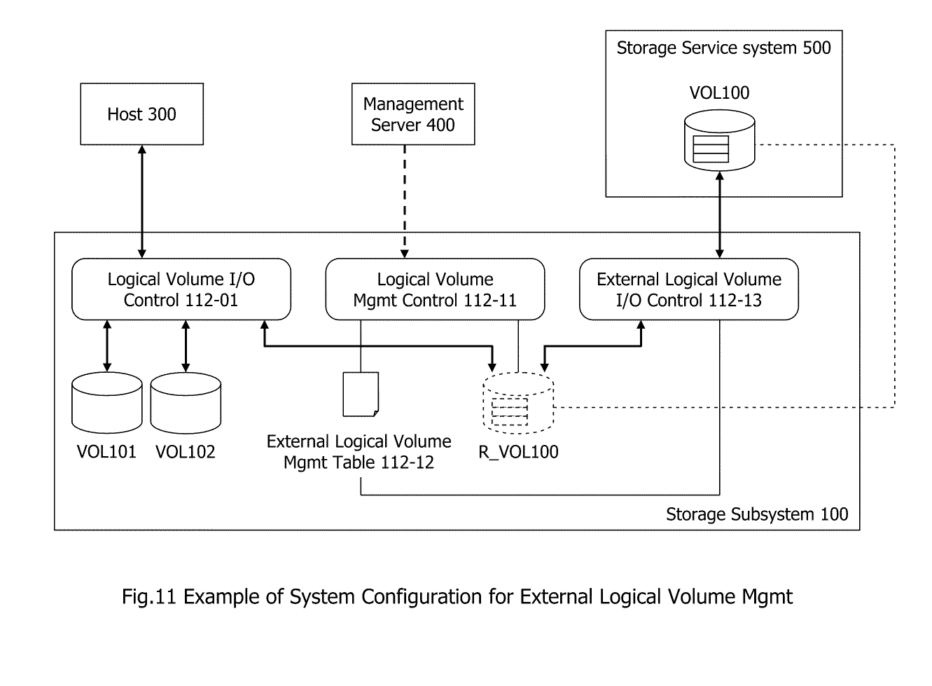

FIG. 11 illustrates another example of the system configuration for external logical volume management. As in the example of FIG. 6, the first storage subsystem 100 in this example also allows the host computer 300 to issue read/write I/O access to R_VOL100 by utilizing the logical volume I/O control 112-01. Unlike the example of FIG. 6, the logical volume I/O control 112-01 in this example transfers I/O requests from the host computer 300 to the external logical volume I/O control 112-13 in the first storage subsystem 100 to reach the actual logical volume VOL100 in the storage service system 500.

When the logical volume I/O control 112-01 receives a read I/O command toward a certain page from the host computer 300, the logical volume I/O control 112-01 looks up the external logical volume management table 112-12 to find out which URI is related to its requested page (e.g., read I/O toward 0x0100 means http://500b.com/001301). After that, the external logical volume I/O control 112-13 obtains the related URI data from the storage service system 500.

When the logical volume I/O control 112-01 receives a write I/O command toward a certain page from the host computer 300, the logical volume I/O control 112-01 looks up the external logical volume management table 112-12 to find out which URI is related to its requested page (e.g., write I/O toward 0x0100 means http://500b.com/001301, write I/O toward 0x0200 means create new URI). After that, the external logical volume I/O control 112-13 writes data to the related URI in the storage service system 500.

As described, the logical volume management control 112-11 and the external logical volume management table 112-12 for R_VOL100 in the first storage subsystem 100 enables the administrator to manage VOL100 in the storage service system 500 even if the storage service system 500 does not offer any interface and/or capability of logical volume management to the administrator. Further, the external logical volume I/O control 112-13 in the storage subsystem 100 enables the host computer 300 to issue read/write I/O to VOL 100 via R_VOL100 even if the host computer 300 does not have direct connectivity to the storage service system 500.

2. External Storage Subsystem Logical Volume (with I/O Capability)

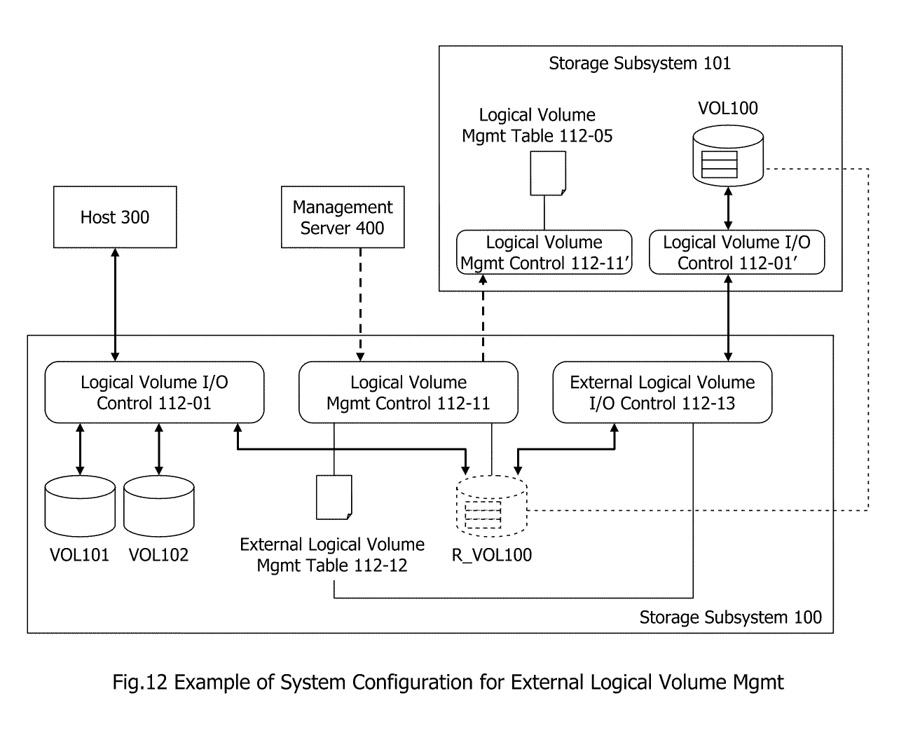

FIG. 12 illustrates another example of the system configuration for external logical volume management. Instead of the storage service system 500 in FIG. 6 and FIG. 11, FIG. 12 shows a second storage subsystem 101 as an external storage subsystem. The second storage subsystem 101 has VOL100, a logical volume I/O control 112-01′, a logical volume management table 112-05, and a logical volume management control 112-11′. The external logical volume I/O control 112-13 in the first storage subsystem 100 communicates with the logical volume I/O control 112-01′ in the second storage subsystem 101 to access VOL100. The logical volume management control 112-11 in the first storage subsystem 100 communicates with the logical volume management control 112-11′ in the second storage subsystem 101 to access the logical volume management table 112-05.

As in the example of FIG. 6, when the administrator needs to operate VOL100 (such as create, delete, change attributes, and the like), the management server 400 accesses the logical volume management control 112-11 in the first storage subsystem 100. The logical volume management control 112-11 allows the management server 400 to operate R_VOL100 which is virtualized logical volume of VOL100 in the second storage subsystem 101. All operation from the management server 400 to R_VOL100 is reflected directly to VOL100.

The first storage subsystem 100 allows the host computer 300 to issue read/write I/O access to R_VOL100 by utilizing the logical volume I/O control 112-01. The logical volume I/O control 112-01 transfers I/O requests from the host computer 300 to the external logical volume I/O control 112-13 to reach the actual logical volume VOL100 in the second storage subsystem 101.

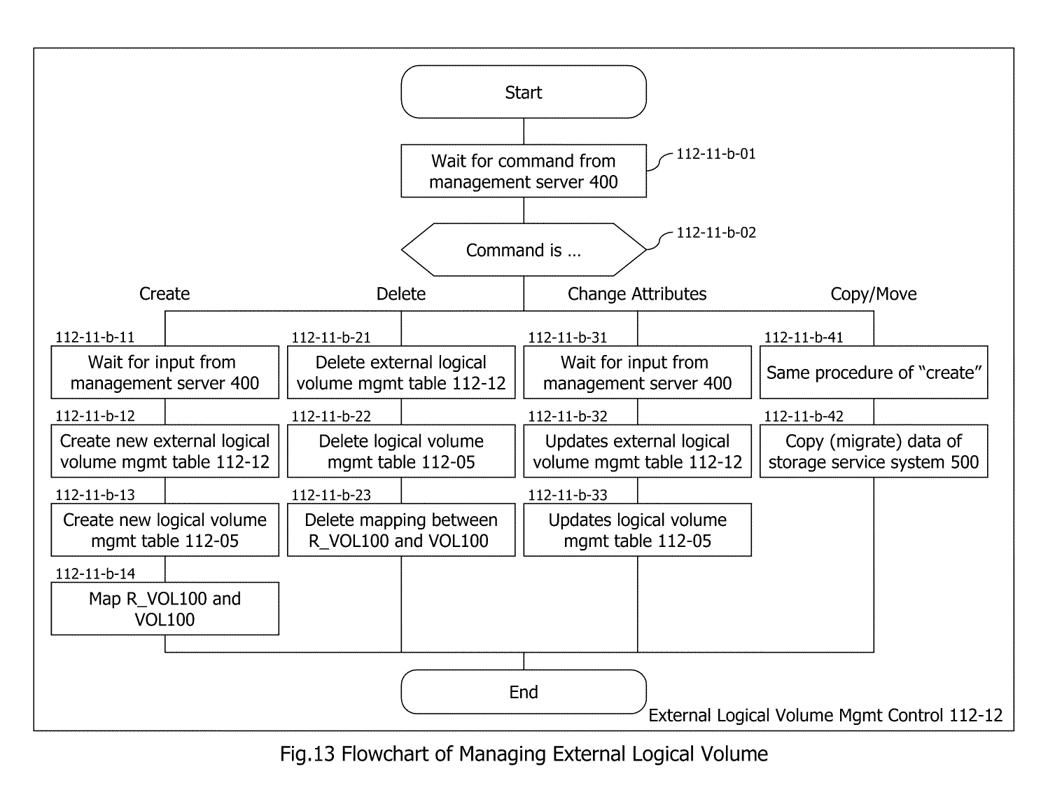

FIG. 13 illustrates an example of a flow diagram of managing an external logical volume VOL100 in the second storage subsystem 101 of FIG. 12 via R_VOL100 in the first storage subsystem 100. This is accomplished because the logical volume management control 112-11 in the first storage subsystem 100 can reach the logical volume management control 112-11′ in the second storage subsystem 101.

At first, the logical volume management control 112-11 in the first storage subsystem 100 waits for an operational command from the management server 400, administrator, or the like (112-11-b-01). The next step is to direct the process to the appropriate flow path based on what the command is (112-11-b-02).

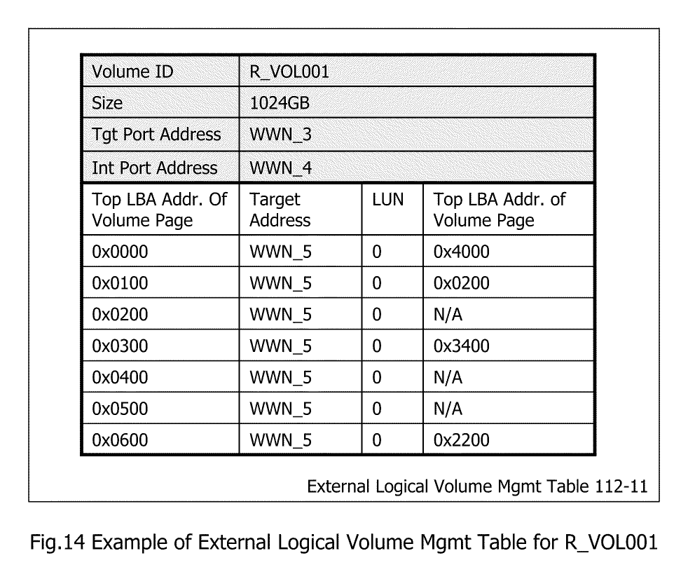

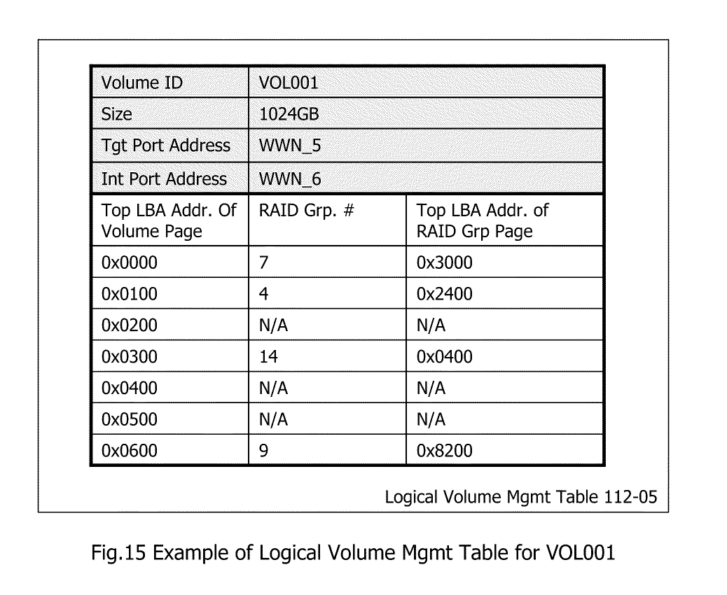

If the command is “Create,” the logical volume management control 112-11 in the first storage subsystem 100 creates a virtual logical volume (R_VOL100) in the first storage subsystem 100 which represents the logical volume (VOL100) in the second storage subsystem 101. The management server 400, administer, or the like inputs the attribute information about the logical volume such as name, total size, block size, etc. (112-11-b-11). After realizing the attributes, the logical volume management control 112-11 in the first storage subsystem 100 creates a new external logical volume table 112-12 (see, e.g., FIG. 14) for R_VOL100 and VOL100 (112-11-b-12). In the example shown in FIG. 14, VOL100 can be accessed from the external logical volume I/O control 112-13 by the target address “WWN5” and LUN “0.” Next, the logical volume management control 112-11 in the first storage subsystem 100 invokes the logical volume management control 112-11′ in second storage subsystem 101 to create a logical volume management table 112-05 for VOL100 in the second storage subsystem 101 (112-11-b-13). FIG. 15 shows an example of the logical volume management table 112-05 for VOL100. Next, the logical volume management control 112-11 in the first storage subsystem 100 associates R_VOL100 and VOL100 as the external virtual logical volume (112-11-b-14). This means that read/write I/O from the host computer 300 to R_VOL100 is transferred to VOL100 by the external logical volume I/O control 112-13 in the first storage subsystem 100.

If command is “Delete,” the logical volume management control 112-11 in the first storage subsystem 100 deletes the external logical volume management table 112-12 for R_VOL100 (112-11-b-21), and invokes the logical volume management control 112-11′ in the second storage subsystem 101 to delete the logical volume management table for VOL100 (112-11-b-22). The logical volume management control 112-11 in the first storage subsystem 100 further deletes association between R_VOL100 and VOL100 (112-11-b-23).

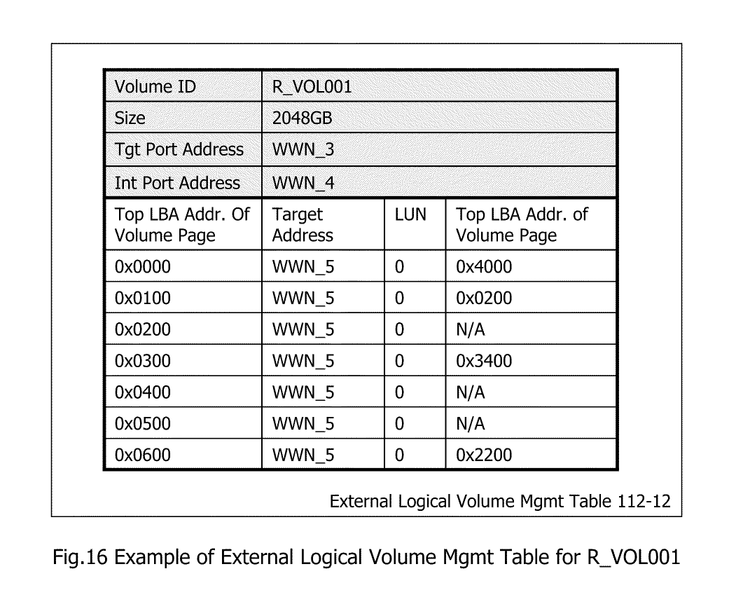

If command is “Change Attributes,” the logical volume management control 112-11 in the first storage subsystem 100 changes the attributes of R_VOL100, and invokes the logical volume management control 112-11′ in the second storage subsystem 101 to change the attributes of VOL100. The management server 400, administrator, or the like inputs the attribute information about R_VOL100, VOL100 (112-11-b-31), and then the logical volume management control 112-11 in first storage subsystem 100 updates the specified attributes of R_VOL100 as shown in the updated external logical volume management table of FIG. 16 (112-11-b-32). It also changes the attributes of VOL100 by updating the logical volume management table 112-05 in the second storage subsystem 101 (112-11-b-33).

If command is “Copy/Move,” the logical volume management control 112-11 in the first storage subsystem 100 creates another virtual logical volume (R_VOL200) in the first storage subsystem 100 which represents another logical volume (VOL200) in the first storage subsystem 101 (112-11-b-41). Next, the logical volume management control 112-11 in the first storage subsystem 100 directs the external logical volume I/O control 112-13 to copy the data of R_VOL100 (VOL100) to R_VOL200 (VOL200). If the operation is move, the logical volume management control 112-11 in the first storage subsystem 100 deletes R_VOL100 (VOL100) after the copy process (112-11-b-42).

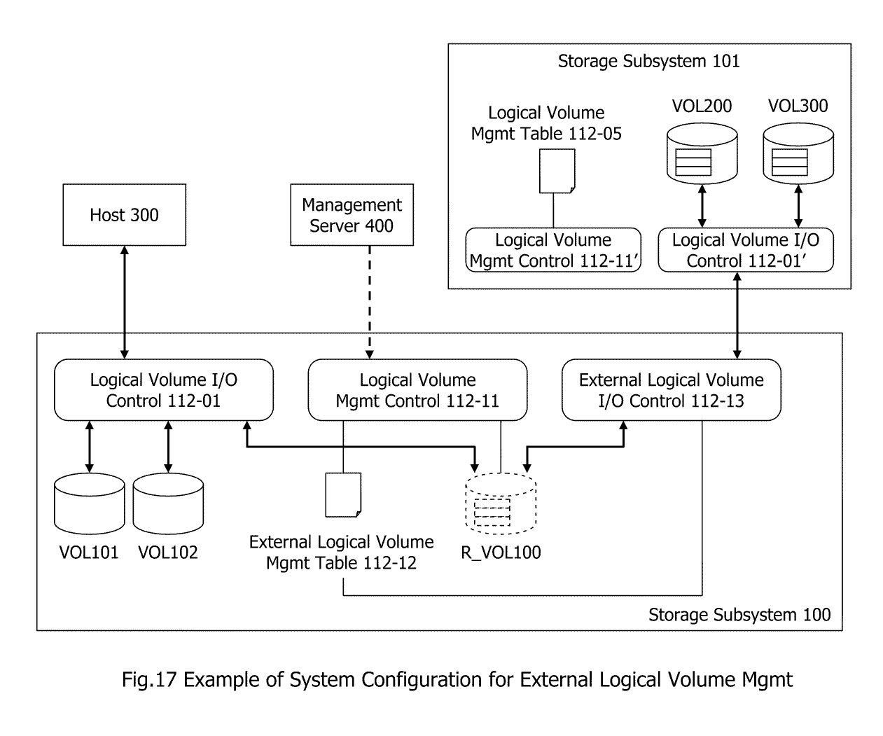

FIG. 17 illustrates another example of the system configuration for external logical volume management, without connectivity between the logical volume management control 112-11 in the first storage subsystem 100 and the logical volume management control 112-11′ in the second storage subsystem 101 (as opposed to connectivity in FIG. 12). In this case, the logical volume management control 112-11 in the first storage subsystem 100 does not invoke the logical volume management control 112-11′ in the second storage subsystem 101 to operate the logical volume in the second storage subsystem 101. All required logical volume configuration is managed by the first storage subsystem 100 as provided in the external logical volume management table 112-12. In order to achieve this, the external logical volume I/O control 112-13 in the first storage subsystem 100 uses one or more logical volumes in the second storage subsystem 101 as storage page pool.

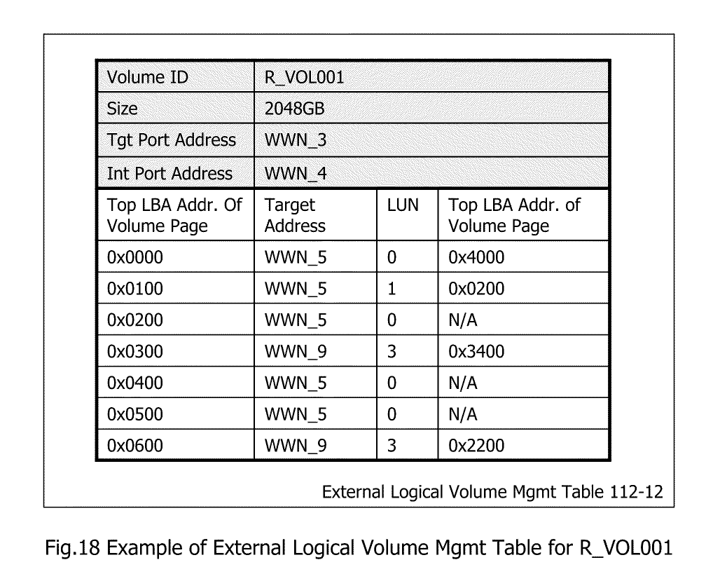

FIG. 18 illustrates an example of an external logical volume management table 112-12 in the first storage subsystem 100 of FIG. 17. The table 112-12 of FIG. 18 is used to manage one or more pages from the second storage subsystem 101 for R_VOL100. As shown in this example, R_VOL100 can be comprised of one or more logical volumes of the second storage subsystem 101 (VOL200, VOL300). It allows the management server 400 and the logical volume management control 112-11 in the first storage subsystem 100 not to manage the second storage subsystem 101 directly.

As described, the logical volume management control 112-11 and external logical volume management table 112-12 for R_VOL100 in the first storage subsystem 100 enables the administrator to manage VOL100 in the second storage subsystem 101 even if the second storage subsystem 101 does not offer any interface and/or capability of logical volume management to the administrator. The external logical volume I/O control 112-13 in the first storage subsystem 100 enables the host computer 300 to issue read/write I/O to VOL 100 via R_VOL100 even if the host computer 300 does not have direct connectivity to the second storage subsystem 101.

Of course, the system configurations illustrated in FIGS. 1, 3, 6, 11, 12, and 17 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for logical volume management between multiple storage subsystems or between one or more storage subsystems and a storage service such as a cloud storage computing service. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. In a system having a host computer, a storage subsystem, an external system connected with the storage subsystem, and a management computer for managing one or more storage volumes in the external system via the storage subsystem, the storage subsystem comprising:
a volume I/O control to expose one or more volumes in the storage subsystem to the host computer to provide storage I/O capability; and
a volume management control to allow the management server to operate a second volume in the external system by operating a first volume in the storage subsystem, the volume management control being configured, in response to a command from the management server to create the first volume, to create the first volume in the storage subsystem and to create the second volume in the external system, and in response to a command from the management server to delete the first volume, to delete the first volume in the storage subsystem and to delete the second volume in the external system;
wherein data in the first volume is stored in the second volume.

2. The storage subsystem according to claim 1,
wherein the volume management control creates an external volume management table for the first volume and the second volume in response to the command to create the first volume;
wherein the volume management control deletes an external volume management table for the first volume and the second volume in response to the command to delete the first volume; and
wherein the external volume management table provides configuration information and mapping information of the first volume and the second volume to manage configuration and mapping of the first volume and the second volume.

3. The storage subsystem according to claim 1,
wherein the volume I/O control processes read/write I/O from the host computer to the first volume;
wherein the storage subsystem further comprises an external volume I/O control which transfers the read/write I/O, from the host computer for the first volume, to the second volume in the external system.

4. The storage subsystem according to claim 1,
wherein the external system is one of a storage service system having multiple URI (Uniform Resource Identifier) resources or another storage subsystem.

5. The storage subsystem according to claim 1, wherein the external system is a second storage subsystem, the storage subsystem further comprising:
an external volume I/O control which communicates with a second volume I/O control of the second storage subsystem to access the second volume in the second storage subsystem;
wherein the volume management control communicates with a second volume management control of the second storage subsystem to operate the second volume in the second storage subsystem.

6. The storage subsystem according to claim 1, wherein the external system is a second storage subsystem, the storage subsystem further comprising:
an external volume I/O control which communicates with a second volume I/O control of the second storage subsystem to access the second volume in the second storage subsystem, and utilizes one or more volumes in the second storage subsystem as a storage pool.

7. In a system having a host computer, a storage subsystem, an external system connected with the storage subsystem, and a management computer for managing one or more storage volumes in the external system via the storage subsystem, the storage subsystem comprising:
a volume I/O control to expose one or more volumes in the storage subsystem to the host computer to provide storage I/O capability; and
a volume management control to allow the management server to operate a second volume in the external system by operating a first volume in the storage subsystem, the volume management control being configured, in response to a command other than a read/write command from the management server to operate the first volume, to apply the command to the first volume in the storage subsystem and to apply the command to the second volume in the external system;
wherein data in the first volume is stored in the second volume.

8. The storage subsystem according to claim 7,
wherein the command is one of a create command to create the first volume, a delete command to delete the first volume, a change attribute command to change attribute of the first volume, a copy command to copy the first volume, or a move command to move the first volume;
wherein in response to the create command, the volume management control creates the first volume in the storage subsystem and creates the second volume in the external system;
wherein in response to the delete command, the volume management control deletes the first volume in the storage subsystem and deletes the second volume in the external system;
wherein in response to the change attribute command, the volume management control changes attribute of the first volume in the storage subsystem and changes attribute of the second volume in the external system;
wherein in response to the copy command, the volume management control copies the first volume to a first target volume in the storage subsystem, and copies the second volume to a second target volume in the external system; and
wherein in response to the move command, the volume management control copies the first volume to a first target volume in the storage subsystem and deletes the first volume, and copies the second volume to a second target volume in the external system and deletes the second volume.

9. The storage subsystem according to claim 8,
wherein in response to the create command, the volume management control creates an external volume management table for the first volume and the second volume;
wherein in response to the delete command, the volume management control deletes an external volume management table for the first volume and the second volume;
wherein in response to the change attribute command, the volume management control updates the external volume management table for the first volume and the second volume based on change in the attributes of the first volume and the second volume;
wherein in response to the copy command, the volume management control creates another external volume management table for the first target volume and the second target volume; and
wherein in response to the move command, the volume management control creates another external volume management table for the first target volume and the second target volume, and deletes the external volume management table for the first volume and the second volume;
wherein the external volume management table provides configuration information and mapping information of the first volume and the second volume to manage configuration and mapping of the first volume and the second volume; and
wherein the another external volume management table provides configuration information and mapping information of the first target volume and the second target volume to manage configuration and mapping of the first target volume and the second target volume.

10. The storage subsystem according to claim 7,
wherein the volume I/O control processes read/write I/O from the host computer to the first volume;
wherein the storage subsystem further comprises an external volume I/O control which transfers the read/write I/O, from the host computer for the first volume, to the second volume in the external system.

11. The storage subsystem according to claim 7,
wherein the external system is one of a storage service system having multiple URI (Uniform Resource Identifier) resources or another storage subsystem; and
wherein the external system provides no management capability and no management interface to the management computer.

12. The storage subsystem according to claim 7, wherein the external system is a second storage subsystem, the storage subsystem further comprising:
an external volume I/O control which communicates with a second volume I/O control of the second storage subsystem to access the second volume in the second storage subsystem;
wherein the volume management control communicates with a second volume management control of the second storage subsystem to operate the second volume in the second storage subsystem.

13. The storage subsystem according to claim 7, wherein the external system is a second storage subsystem, the storage subsystem further comprising:
an external volume I/O control which communicates with a second volume I/O control of the second storage subsystem to access the second volume in the second storage subsystem, and utilizes one or more volumes in the second storage subsystem as a storage pool.

14. In a system having a host computer, a storage subsystem, an external system connected with the storage subsystem, and a management computer for managing one or more storage volumes in the external system via the storage subsystem, the storage subsystem comprising:
a volume I/O control to expose one or more volumes in the storage subsystem to the host computer to provide storage I/O capability; and
a volume management control to allow the management server to operate a second volume in the external system by operating a first volume in the storage subsystem and to manage the first volume and the second volume using an external volume management table stored in the storage subsystem, the external volume management table providing configuration information and mapping information of the first volume and the second volume to manage configuration and mapping of the first volume and the second volume;
wherein data in the first volume is stored in the second volume; and
wherein the external system has a Hypertext Transfer Protocol interface.

15. The storage subsystem according to claim 14,
wherein the command is one of a create command to create the first volume, a delete command to delete the first volume, a change attribute command to change attribute of the first volume, a copy command to copy the first volume, or a move command to move the first volume;
wherein in response to the create command, the volume management control creates the first volume in the storage subsystem and creates the second volume in the external system;
wherein in response to the delete command, the volume management control deletes the first volume in the storage subsystem and deletes the second volume in the external system;
wherein in response to the change attribute command, the volume management control changes attribute of the first volume in the storage subsystem and changes attribute of the second volume in the external system;
wherein in response to the copy command, the volume management control copies the first volume to a first target volume in the storage subsystem, and copies the second volume to a second target volume in the external system; and
wherein in response to the move command, the volume management control copies the first volume to a first target volume in the storage subsystem and deletes the first volume, and copies the second volume to a second target volume in the external system and deletes the second volume.

16. The storage subsystem according to claim 15,
wherein in response to the create command, the volume management control creates an external volume management table for the first volume and the second volume;
wherein in response to the delete command, the volume management control deletes an external volume management table for the first volume and the second volume; and
wherein in response to the change attribute command, the volume management control updates the external volume management table for the first volume and the second volume based on change in the attributes of the first volume and the second volume.
wherein in response to the copy command, the volume management control creates another external volume management table for the first target volume and the second target volume;
wherein in response to the move command, the volume management control creates another external volume management table for the first target volume and the second target volume, and deletes the external volume management table for the first volume and the second volume;
wherein the external volume management table provides configuration information and mapping information of the first volume and the second volume to manage configuration and mapping of the first volume and the second volume; and
wherein the another external volume management table provides configuration information and mapping information of the first target volume and the second target volume to manage configuration and mapping of the first target volume and the second target volume.

17. The storage subsystem according to claim 14,
wherein the volume I/O control processes read/write I/O from the host computer to the first volume;
wherein the storage subsystem further comprises an external volume I/O control which transfers the read/write I/O, from the host computer for the first volume, to the second volume in the external system.

18. The storage subsystem according to claim 14,
wherein the external system is one of a storage service system having multiple URI (Uniform Resource Identifier) resources or another storage subsystem.

19. The storage subsystem according to claim 14, wherein the external system is a second storage subsystem, the storage subsystem further comprising:
an external volume I/O control which communicates with a second volume I/O control of the second storage subsystem to access the second volume in the second storage subsystem;
wherein the volume management control communicates with a second volume management control of the second storage subsystem to operate the second volume in the second storage subsystem.

20. The storage subsystem according to claim 14, wherein the external system is a second storage subsystem, the storage subsystem further comprising:
an external volume I/O control which communicates with a second volume I/O control of the second storage subsystem to access the second volume in the second storage subsystem, and utilizes one or more volumes in the second storage subsystem as a storage pool.
